(19) United States
(12) Patent Application Publication
(10) Pub. No.: US 2025/0151016 A1
(43) Pub. Date: May 8, 2025

(54) METHOD AND APPARATUS FOR LOCATION VERFICATION IN COMMUNICATION SYSTEM

(71) Applicant: ELECTRONICS AND TELECOMMUNICATIONS RESEARCH INSTITUTE, Daejeon (KR)

(72) Inventors: Jung-bin KIM, Daejeon (KR); Jihung KIM, Daejeon (KR)

(73) Assignee: ELECTRONICS AND TELECOMMUNICATIONS RESEARCH INSTITUTE, Daejeon (KR)

(21) Appl. No.: 18/935,206

(22) Filed: Nov. 1, 2024

(30) Foreign Application Priority Data
Nov. 3, 2023 (KR) 10-2023-0151020
Nov. 1, 2024 (KR) 10-2024-0153603

(51) Int. Cl. H04W 64/00

(52) U.S. Cl. CPC H04W 64/00

(57) ABSTRACT

A method of a base station may comprise: receiving, from a location management function (LMF) device, location information request common information elements (IEs) including indication information on a location information reporting type and reporting criteria information on reporting criteria according to the location information reporting type; providing, to a terminal, the location information request common IEs including the indication information and the reporting criteria information; receiving, from the terminal, a location information report according to the indication information and the reporting criteria information; and providing the received location information report to the LMF device.

### CROSS-REFERENCE TO RELATED APPLICATIONS

This application claims priority to Korean Patent Applications No. 10-2023-0151020, filed on Nov. 3, 2023, and No. 10-2024-0153603, filed on Nov. 1, 2024, with the Korean Intellectual Property Office (KIPO), the entire contents of which are hereby incorporated by reference.

### BACKGROUND

### 1. Technical Field

The present disclosure relates to a location verification technique in a communication system, and more particularly, to a location verification technique for providing services with an appropriate quality to a terminal moving in a non-terrestrial network.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Such communication networks may be classified as terrestrial networks, as they provide communication services to terminals located in terrestrial locations. Recently, the demand for communication services has been increasing not only for terrestrial locations but also for non-terrestrial locations, such as unmanned aerial vehicles and satellites. To address this, the 3GPP is discussing technologies for non-terrestrial networks (NTNs). In such non-terrestrial networks, since a terminal can move, mobility management of the terminal may be required to provide an appropriate quality of service to the terminal. As part of the mobility management, it may be required to determine a location of the terminal.

### SUMMARY

The present disclosure for resolving the above-described problems is directed to providing a method and apparatus for location verification, which facilitate provision of a service with an appropriate quality to a terminal moving in a non-terrestrial network.

A location verification method in a communication system, according to a first exemplary embodiment of the present disclosure, may comprise, as the steps performed by a base station, receiving, from a location management function (LMF) device, location information request common information elements (IEs) including indication information on a location information reporting type and reporting criteria information on reporting criteria according to the location information reporting type; providing, to a terminal, the location information request common IEs including the indication information and the reporting criteria information; receiving, from the terminal, a location information report according to the indication information and the reporting criteria information; and providing the received location information report to the LMF device.

The location information reporting type may be at least one of a periodic reporting, response time-based reporting, or event-based reporting.

When the location information reporting type is the periodic reporting, the indication information may be a periodic report IE, and the reporting criteria information may include at least one of a reporting interval, a reporting amount, or an interval unit.

The reporting interval may be at least one of 1 second, 2 seconds, 4 seconds, 8 seconds, 16 seconds, 32 seconds, 64 seconds, 128 seconds, or 256 seconds, the reporting amount may be at least one of 1 time, 2 times, 4 times, 8 times, 16 times, 32 times, 64 times, 128 times, or 256 times, and the interval unit may be at least one of 1 second, 2 seconds, 3 seconds, or 4 seconds.

A transmission periodicity of the location information report may be set to a value obtained by multiplying the reporting interval by the interval unit.

When the location information reporting type is the response time-based reporting, the indication information may be a response time parameter, and the reporting criteria information may include at least one of a response time, a reporting interval, or a reporting amount.

When the location information reporting type is the event-based reporting, the indication information may be a triggered reporting IE, and the reporting criteria information may include at least one of a reporting event, a reporting duration, a reporting interval, or a reporting amount.

A location verification method in a communication system, according to a second exemplary embodiment of the present disclosure, may comprise, as the steps performed by a terminal, receiving, from a base station, location information request common information elements (IEs) including indication information on a location information reporting type and reporting criteria information on reporting criteria according to the location information reporting type; identifying the location information reporting type based on the indication information; identifying the reporting criteria information according to the identified location information reporting type; generating location information based on the location information reporting type; and transmitting the generated location information to the base station according to the reporting criteria information.

The identifying of the location information reporting type based on the indication information may comprise: identifying a periodic reporting IE as the indication information from the location information request common IEs; and in response to identifying the periodic reporting IE, determining the location information reporting type as a periodic reporting.

The identifying of the location information reporting type based on the indication information may comprise: identifying a response time parameter as the indication information from the location information request common IEs; and in response to identifying the response time parameter, determining the location information reporting type as a response time-based reporting.

The identifying of the location information reporting type based on the indication information may comprise: identifying a triggered reporting IE as the indication information from the location information request common IEs; and in response to identifying the triggered reporting IE, determining the location information reporting type as an event-based reporting.

When the location information reporting type is a periodic reporting, the reporting criteria information may include at least one of a reporting interval, a reporting amount, or an interval unit.

The reporting interval may be at least one of 1 second, 2 seconds, 4 seconds, 8 seconds, 16 seconds, 32 seconds, 64 seconds, 128 seconds, or 256 seconds, the reporting amount may be at least one of 1 time, 2 times, 4 times, 8 times, 16 times, 32 times, 64 times, 128 times, or 256 times, and the interval unit may be at least one of 1 second, 2 seconds, 3 seconds, or 4 seconds.

A transmission periodicity of the location information report may be set to a value obtained by multiplying the reporting interval by the interval unit.

When the location information reporting type is a response time-based reporting, the reporting criteria information may include at least one of a response time, a reporting interval, or a reporting amount.

When the location information reporting type is an event-based reporting, the reporting criteria information may include at least one of a reporting event, a reporting duration, a reporting interval, or a reporting amount.

A location verification apparatus in a communication system, according to a third exemplary embodiment of the present disclosure, may comprise a terminal including a processor, wherein the processor causes the terminal to perform: receiving, from a base station, location information request common information elements (IEs) including indication information on a location information reporting type and reporting criteria information on reporting criteria according to the location information reporting type; identifying the location information reporting type based on the indication information; identifying the reporting criteria information according to the identified location information reporting type; generating location information based on the location information reporting type; and transmitting the generated location information to the base station according to the reporting criteria information.

In the identifying of the location information reporting type based on the indication information, the processor may cause the terminal to perform: identifying a periodic reporting IE as the indication information from the location information request common IEs; and in response to identifying the periodic reporting IE, determining the location information reporting type as a periodic reporting.

In the identifying of the location information reporting type based on the indication information, the processor may cause the terminal to perform: identifying a response time parameter as the indication information from the location information request common IEs;

and in response to identifying the response time parameter, determining the location information reporting type as a response time-based reporting.

In the identifying of the location information reporting type based on the indication information, the processor may cause the terminal to perform: identifying a triggered reporting IE as the indication information from the location information request common IEs; and in response to identifying the triggered reporting IE, determining the location information reporting type as an event-based reporting.

According to the present disclosure, a base station can provide a terminal, which moves within a non-terrestrial network, with information elements that include a location information reporting type and reporting criteria. The terminal can receive the location information reporting type and reporting criteria from the base station. The terminal can provide location information to the base station according to the location information reporting type and reporting criteria. The base station can receive the location information from the terminal and determine the terminal's location. Accordingly, the base station can perform mobility management of the terminal to provide an appropriate quality of service to the terminal.

### BRIEF DESCRIPTION OF DRAWINGS

FIG. 1 is a conceptual diagram illustrating a first exemplary embodiment of a non-terrestrial network.

FIG. 2 is a conceptual diagram illustrating a second exemplary embodiment of a non-terrestrial network.

FIG. 3 is a block diagram illustrating a first exemplary embodiment of an entity constituting a non-terrestrial network.

FIG. 4 is a sequence chart illustrating a first exemplary embodiment of a location verification method in a communication system.

FIG. 5 is a sequence chart illustrating a second exemplary embodiment of a location verification method in a communication system.

FIG. 6 is a sequence chart illustrating a third exemplary embodiment of a location verification method in a communication system.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication system may be a non-terrestrial network (NTN), a 4G communication network (e.g. long-term evolution (LTE) communication network), a 5G communication network (e.g. new radio (NR) communication network), a 6G communication network, or the like. The 4G communication network, 5G communication network, and 6G communication network may be classified as terrestrial networks.

The NTN may operate based on the LTE technology and/or the NR technology. The NTN may support communications in frequency bands below 6 GHz as well as in frequency bands above 6 GHz. The 4G communication network may support communications in the frequency band below 6 GHz. The 5G communication network may support communications in the frequency band below 6 GHz as well as in the frequency band above 6 GHz. The communication network to which the exemplary embodiments according to the present disclosure are applied is not limited to the contents described below, and the exemplary embodiments according to the present disclosure may be applied to various communication networks. Here, the communication network may be used in the same sense as the communication system.

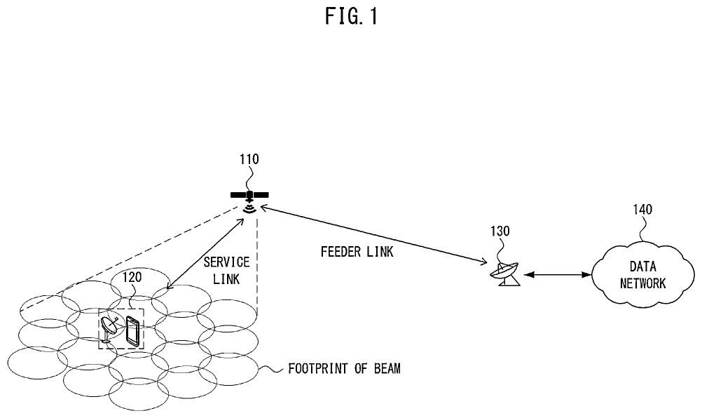

FIG. 1 is a conceptual diagram illustrating a first exemplary embodiment of a non-terrestrial network.

Referring to FIG. 1, a non-terrestrial network (NTN) may include a satellite 110, a communication node 120, a gateway 130, a data network 140, and the like. The NTN shown in FIG. 1 may be an NTN based on a transparent payload. The satellite 110 may be a low earth orbit (LEO) satellite (at an altitude of 300 to 1,500 km), a medium earth orbit (MEO) satellite (at an altitude of 7,000 to 25,000 km), a geostationary earth orbit (GEO) satellite (at an altitude of about 35,786 km), a high elliptical orbit (HEO) satellite, or an unmanned aircraft system (UAS) platform. The UAS platform may include a high altitude platform station (HAPS).

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical.

The communication node 120 may perform communications (e.g. downlink communication and uplink communication) with the satellite 110 using LTE technology and/or NR technology. The communications between the satellite 110 and the communication node 120 may be performed using an NR-Uu interface. When dual connectivity (DC) is supported, the communication node 120 may be connected to other base stations (e.g. base stations supporting LTE and/or NR functionality) as well as the satellite 110, and perform DC operations based on the techniques defined in the LTE and/or NR specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the NR technology. For example, the core network may include an access and mobility management function (AMF), a user plane function (UPF), a session management function (SMF), and the like. The communications between the gateway 130 and the core network may be performed based on an NG-C/U interface.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR technology. The communications between the gateway 130 and the base station may be performed based on an NR-Uu interface, and the communications between the base station and the core network (e.g. AMF, UPF, SMF, and the like) may be performed based on an NG-C/U interface.

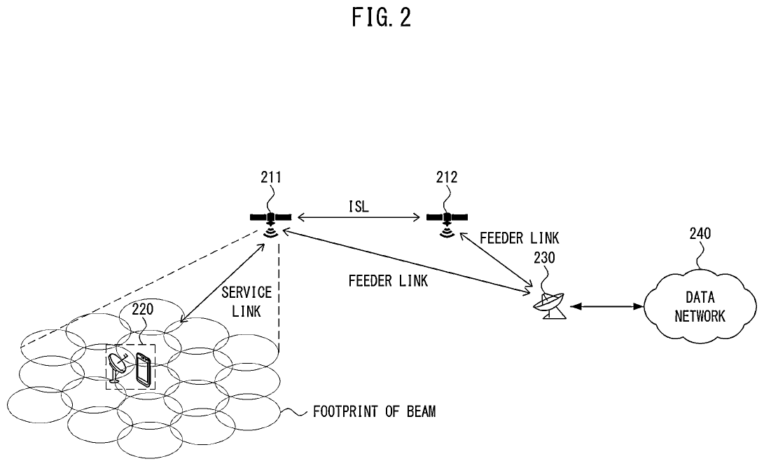

FIG. 2 is a conceptual diagram illustrating a second exemplary embodiment of a non-terrestrial network.

Referring to FIG. 2, a non-terrestrial network may include a first satellite 211, a second satellite 212, a communication node 220, a gateway 230, a data network 240, and the like. The NTN shown in FIG. 2 may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink (DL) communication or uplink (UL) communication) with the satellite 211 using LTE technology and/or NR technology. The communications between the satellite 211 and the communication node 220 may be performed using an NR-Uu interface. When DC is supported, the communication node 220 may be connected to other base stations (e.g. base stations supporting LTE and/or NR functionality) as well as the satellite 211, and may perform DC operations based on the techniques defined in the LTE and/or NR specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily.

The communications between each of the satellites 211 and 212 and the gateway 230 may be performed based on an NR-Uu interface or an SRI. The gateway 230 may be connected to the data network 240. There may be a core network between the gateway 230 and the data network 240. In this case, the gateway 230 may be connected to the core network, and the core network may be connected to the data network 240. The core network may support the NR technology. For example, the core network may include AMF, UPF, SME, and the like. The communications between the gateway 230 and the core network may be performed based on an NG-C/U interface.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology. The communications between the gateway 230 and the base station may be performed based on an NR-Uu interface, and the communications between the base station and the core network (e.g. AMF, UPF, SMF, and the like) may be performed based on an NG-C/U interface.

Meanwhile, entities (e.g. satellites, communication nodes, gateways, etc.) constituting the NTNs shown in FIGS. 1 and 2 may be configured as follows.

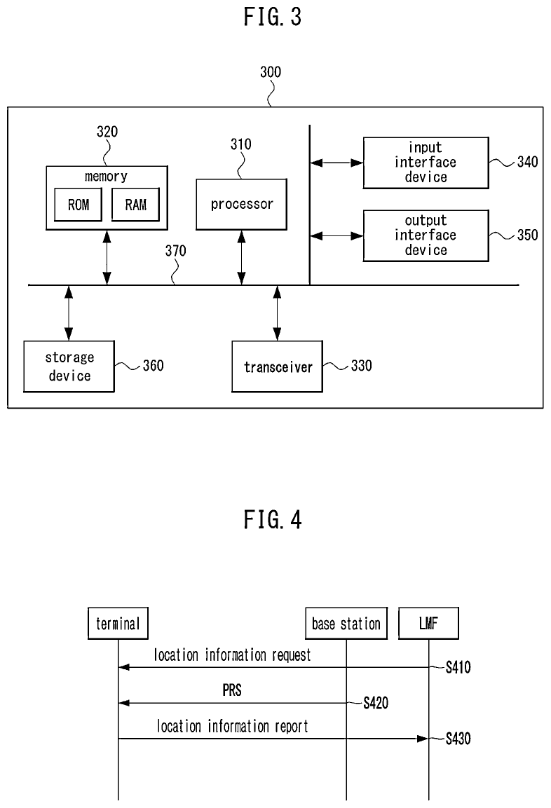

FIG. 3 is a block diagram illustrating a first exemplary embodiment of an entity constituting a non-terrestrial network.

Referring to FIG. 3, an entity 300 may include at least one processor 310, a memory 320, and a transceiver 330 connected to a network to perform communication. In addition, the entity 300 may further include an input interface device 340, an output interface device 350, a storage device 360, and the like. The components included in the entity 300 may be connected by a bus 370 to communicate with each other.

However, each component included in the entity 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

Meanwhile, scenarios in the NTN may be defined as shown in Table 1 below.

TABLE 1

| | NTN shown in FIG. 1 | NTN shown in FIG. 2 |
|---|---|---|
| GEO | Scenario A | Scenario B |
| LEO | Scenario C1 | Scenario D1 |
| (steerable beams) | | |
| LEO | Scenario C2 | Scenario D2 |
| (beams moving | | |
| with satellite) | | |

When the satellite 110 in the NTN shown in FIG. 1 is a GEO satellite (e.g. a GEO satellite that supports a transparent function), this may be referred to as ‘scenario A’. When the satellites 211 and 212 in the NTN shown in FIG. 2 are GEO satellites (e.g. GEOs that support a regenerative function), this may be referred to as ‘scenario B’.

When the satellite 110 in the NTN shown in FIG. 1 is an LEO satellite with steerable beams, this may be referred to as ‘scenario C1’. When the satellite 110 in the NTN shown in FIG. 1 is an LEO satellite having beams moving with the satellite, this may be referred to as ‘scenario C2’. When the satellites 211 and 212 in the NTN shown in FIG. 2 are LEO satellites with steerable beams, this may be referred to as ‘scenario D1’. When the satellites 211 and 212 in the NTN shown in FIG. 2 are LEO satellites having beams moving with the satellites, this may be referred to as ‘scenario D2’. Parameters for the scenarios defined in Table 1 may be defined as shown in Table 2 below.

TABLE 2

| | Scenarios A and B | | Scenarios C and D | |
|---|---|---|---|---|
| Altitude | 35,786 | km | 600 | km |

| | |
|---|---|
| 1,200 | km |

| Spectrum (service link) | <6 GHz (e.g. 2 GHz) | | |
|---|---|---|---|
| | >6 GHz (e.g. DL 20 GHz, UL 30 GHz) | | |
| Maximum channel | 30 MHz for band <6 GHz | | |
| bandwidth capability | 1 GHz for band >6 GHz | | |
| (service link) | | | |
| Maximum distance between | 40,581 | km | 1,932 km (altitude of |
| satellite and communication | | | 600 km) |
| node (e.g. UE) at the | | | 3,131 km (altitude of |
| minimum elevation angle | | | 1,200 km) |
| Maximum round trip delay | Scenario A: 541.46 ms | | Scenario C: (transparent |
| (RTD) | (service and feeder links) | | payload: service and feeder |
| (only propagation delay) | Scenario B: 270.73 ms (only | | links) −5.77 ms (altitude |
| | service link) | | of 60 0 km) −41.77 ms |
| | | | (altitude of 1,200 km) |
| | | | Scenario D: (regenerative |
| | | | payload: only service |
| | | | link) −12.89 ms (altitude |
| | | | of 600 km) −20.89 ms |
| | | | (altitude of 1,200 km) |
| Maximum delay variation | 16 | ms | 4.44 ms (altitude of 600 km) |
| within a single beam | | | 6.44 ms (altitude of 1,200 km) |
| Maximum differential delay | 10.3 | ms | 3.12 ms (altitude of 600 km) |

| | |
|---|---|
| within a cell | 3.18 ms (altitude of 1,200 km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | Scenar- | Scenar- | Scenar- | | Scenar- | |
|---|---|---|---|---|---|---|
| | io A | io B | io C1-2 | | io D1-2 | |
| Satellite altitude | 35,786 km | | 600 km | | | |
| Maximum RTD in a | 541.75 ms | 270.57 ms | 28.41 | ms | 12.88 | ms |
| radio interface between | (worst | | | | | |
| base station and UE | case) | | | | | |
| Minimum RTD in a | 477.14 ms | 238.57 ms | 8 | ms | 4 | ms |

radio interface between
base station and UE

FIG. 4 is a sequence chart illustrating exemplary embodiments of a location verification method in a communication system.

Referring to FIG. 4, a Location Management Function (MLF) device may configure location information request common information elements (IEs) (e.g. CommonIEsRequestLocationInformation). The location information request common IEs may include information indicating a location reporting type. For example, the location reporting type may be a periodic reporting type, a response time-based reporting type, or an event-based reporting type. In the case of the periodic reporting type among these location reporting types, the information indicating the location reporting type may be a periodic reporting IE (e.g. PeriodicalReporting IE).

In the present disclosure, location information reported by a terminal may refer to an actual location of the terminal or measurement value(s) that allow the LMF or network to estimate the location of the terminal. For example, the location information reported by the terminal may be one of physical values required for the network to estimate the terminal's location (such as time, time difference, angle, signal strength, cell ID, etc.), or may indicate a reference signal for estimating physical value(s) required by the network to determine the terminal's location. Alternatively, the location information reported by the terminal may indicate physical value(s) or a reference signal that the network needs to report.

Accordingly, the location information request common IEs may include, for example, the periodic reporting IE (e.g. PeriodicalReporting IE) that includes periodic reporting criteria (e.g. PeriodicalReportingCriteria), as shown in Table 4. Here, the periodic reporting criteria may include information on a reporting interval (e.g. reportingInterval) and information on a reporting amount (e.g. reportingAmount).

The reporting interval may indicate an interval between location information reports. For example, the reporting interval may be set to ri0-25, ri0-5, ri1, ri2, ri4, ri8, ri16, ri32, ri64, ri128, ri256, or the like. The enumerated reporting intervals may correspond to transmission periodicities of 1, 2, 4, 8, 16, 32, 64, 128, and 256 seconds, respectively. The reporting amount may indicate the number of requested periodic location information reports. For example, the reporting amount may be set to ra1, ra2, ra4, ra8, ra16, ra32, ra64, ra128, ra256, . . . , or ra-Infinity. The enumerated reporting amounts may correspond to 1, 2, 4, 8, 16, 32, 64, 128, 256, . . . , and an infinite/indefinite number of transmission times, respectively.

TABLE 4
CommonIEsRequestLocationInformation ::= SEQUENCE {

| locationInformationType | LocationInformationType, | | |
|---|---|---|---|
| triggeredReporting | TriggeredReportingCriteria | OPTIONAL, | -- |

Cond ECID

| | | | |
|---|---|---|---|
| periodicalReporting | PeriodicalReportingCriteria | OPTIONAL, | -- |

Need ON

| | | | |
|---|---|---|---|
| additionalInformation | AdditionalInformation | OPTIONAL, | -- |

Need ON

| | | | |
|---|---|---|---|
| qos | QoS | OPTIONAL, | -- |

Need ON

| | | | |
|---|---|---|---|
| environment | Environment | PTIONAL, | -- |

Need ON

| | | | |
|---|---|---|---|
| locationCoordinateTypes | LocationCoordinateTypes | OPTIONAL, | -- |

Need ON

| | | | |
|---|---|---|---|
| velocityTypes | VelocityTypes | OPTIONAL, | -- |

```
Need ON
    ...,
}
  ...
```

| | |
|---|---|
| PeriodicalReportingCriteria ::= | SEQUENCE { |
| reportingAmount | ENUMERATED {ra1, ra2, ra4, ra8, ra16, ra32, |

ra64, ra128, ra256,..., ra-Infinity} DEFAULT ra-Infinity,

| | |
|---|---|
| reportingInterval | ENUMERATED {noPeriodicalReporting, ri0-25, |

ri0-5, ri1, ri2, ri4, ri8, ri16, ri32, ri64, ri128, ri256}

| | |
|---|---|
| TriggeredReportingCriteria ::= | SEQUENCE { |
| cellChange | BOOLEAN, |
| reportingDuration | ReportingDuration, |

...
}

| | |
|---|---|
| ReportingDuration ::= | INTEGER (0..255) |

...

The LMF device may transmit a location information request message (e.g. requestLocationInformation) which includes the configured location information request common IEs to the terminal via a satellite base station located on a satellite (S410). Subsequently, the terminal may receive the location information request message, which includes the location information request common IEs, from the LMF device via the satellite base station. The terminal may identify the periodic reporting IE from the location information request common IEs of the received location information request message. Through the identified periodic reporting IE, the terminal may determine that the periodic reporting type is the location reporting type. The terminal may also identify the periodic reporting criteria such as the reporting interval and reporting amount from the location information request common IEs.

The satellite base station may transmit Positioning Reference Signals (PRSs) to the terminal. For example, the LMF device may allow or trigger the satellite base station to transmit the PRSs to the terminal. Accordingly, the satellite base station may transmit the PRSs to the terminal (S420). The terminal may receive the PRSs from the satellite base station. The terminal may measure the PRSs and generate a location information report. For example, the terminal may generate the location information report based on m samples of PRS resource instances within a PRS measurement window. Each of the m samples may be based on a single PRS occasion within the PRS measurement window. Here, m may be a positive integer.

The terminal may provide the location information reports to the LMF device via the satellite base station (S430). The terminal may provide the location information reports to the LMF device at time intervals based on a transmission periodicity derived from the reporting interval of the periodic reporting criteria and the number of transmissions based on the reporting amount. For example, the reporting interval may be 256 seconds, and the reporting amount may be 256 times. In such a case, the terminal may transmit the location information reports 256 times at intervals of 256 seconds. In this case, the terminal may transmit the location information reports to the satellite base station. The satellite base station may receive the location information reports from the terminal and forward the received location information reports to the LMF device. The LMF device may receive the location information reports from the terminal via the satellite base station and verify the terminal's location. Additionally, the LMF device may generate a control signal based on the verified location of the terminal and provide the control signal to the satellite base station. The satellite base station may receive the control signal from the LMF device and control the terminal according to the received control signal.

In another exemplary embodiment, the periodic reporting criteria may include at least one of information on a reporting interval (e.g. reportingInterval), information on a reporting amount (e.g. reportingAmount), or information on an interval unit (e.g. unit ENUMERATED). The additional interval unit may be set to 1 second, 2 seconds, 3 seconds, 4 seconds, 5 seconds, . . . 10 seconds, . . . 100 seconds, or the like. The LMF device may transmit a location information request message (e.g. requestLocationInformation) which includes the configured location information request common IEs to the terminal via the satellite base station. Subsequently, the terminal may receive the location information request message, which includes the location information request common IEs, from the LMF device via the satellite base station. The terminal may identify the periodic reporting criteria, including the reporting interval, reporting amount, and interval unit, from the location information request common IEs of the received location information request message.

The satellite base station may transmit PRSs to the terminal. For example, the LMF device may allow or trigger the satellite base station to transmit the PRSs to the terminal. Accordingly, the satellite base station may transmit the PRSs to the terminal. The terminal may receive the PRSs from the satellite base station. The terminal may measure the PRSs and generate a location information report. For example, the terminal may generate the location information report based on m samples of PRS resource instances within a PRS measurement window. Each of the m samples may be based on a single PRS occasion within the PRS measurement window. Here, m may be a positive integer.

The terminal may provide the location information reports to the LMF device via the satellite base station. The terminal may calculate a transmission periodicity by multiplying the reporting interval by the interval unit. For example, if the reporting interval is 64 and the interval unit is 2 seconds, the terminal may calculate a transmission periodicity of 128 seconds. The terminal may provide the location information reports to the satellite base station at time intervals based on the calculated transmission periodicity and the number of transmissions based on the reporting amount. The satellite base station may receive the location information reports from the terminal. The satellite base station may forward the received location information reports to the LMF device. The LMF device may receive the location information reports from the terminal via the satellite base station and verify the terminal's location. Additionally, the LMF device may generate a control signal based on the verified location of the terminal and provide the control signal to the satellite base station. The satellite base station may receive the control signal from the LMF device and control the terminal according to the received control signal.

The above-described exemplary embodiments of the present disclosure are characterized by enabling operations for user location verification in a satellite network, which differs significantly in physical structure from a terrestrial network, using parameters and operations previously used for location verification in terrestrial networks. For example, the present disclosure allows for configuration and reporting at longer intervals than the periodic intervals of terrestrial networks and enables reporting and setting the number of reports suitable for the satellite environment.

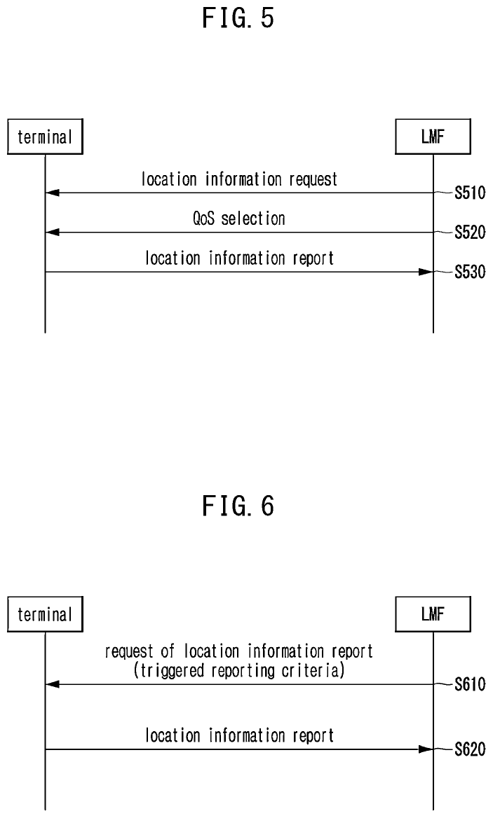

FIG. 5 is a sequence chart illustrating exemplary embodiments of a location verification method in a communication system.

Referring to FIG. 5, the LMF device may configure location information request common IEs (e.g. CommonIEsRequestLocationInformation). The location information request common IEs may include information indicating a location reporting type. For example, the location reporting type may be the periodic reporting type, the response time-based reporting type, or the event-based reporting type. In the case where the location reporting type is the response time-based reporting type, the information indicating the location reporting type may be a response time parameter among Quality of Service (QOS) parameters.

Here, the QoS parameters may include at least one of a horizontal accuracy, vertical coordinate request, vertical accuracy, response time, reporting amount, or reporting interval.

The horizontal accuracy parameter may indicate the maximum horizontal error of a location estimate at a specified confidence level. The vertical coordinate request parameter may indicate whether a vertical coordinate is required (TRUE) or not required (FALSE). The vertical accuracy parameter may indicate the maximum vertical error of a location estimate at a specified confidence level and may only apply when a vertical coordinate is requested. The response time parameter may indicate the maximum response time, such as a time measured between reception of the location information request and transmission of the location information report. If a unit field is not present, the response time parameter may be given as an integer in seconds between 1 and 128. If a unit field is present, the maximum response time may be given in 10-second increments between 10 and 1280 seconds. If the periodic reporting IE (e.g. PeriodicalReporting IE) is included in the location information request common IEs (e.g. CommonIEsRequestLocationInformation), the LMF device may omit the response time parameter. Additionally, if the periodic reporting IE (e.g. PeriodicalReporting IE) is included in the location information request common IEs, the terminal may ignore the response time parameter.

The reporting interval may indicate an interval between location information reports. For example, the reporting interval may be set to ri0-25, ri0-5, ri1, ri2, ri4, ri8, ri16, ri32, ri64, ri128, ri256, or the like. The enumerated reporting intervals may correspond to transmission periodicities of 1, 2, 4, 8, 16, 32, 64, 128, and 256 seconds, respectively. The reporting amount may indicate the number of requested periodic location information reports. For example, the reporting amount may be set to ra1, ra2, ra4, ra8, ra16, ra32, ra64, ra128, ra256, . . . , or ra-Infinity. The enumerated reporting amounts may correspond to 1, 2, 4, 8, 16, 32, 64, 128, 256, . . . , and an infinite/indefinite number of transmission times, respectively.

The LMF device may transmit a location information request message (e.g. requestLocationInformation) which includes the configured location information request common IEs to the terminal via the satellite base station (S510). Subsequently, the terminal may receive the location information request message, which includes the location information request common IEs, from the LMF device via the satellite base station. The terminal may identify the response time parameter from the location information request common IEs of the received location information request message. Through the identified response time parameter, the terminal may determine that the location reporting type is the response time-based reporting type. The terminal may also identify the reporting interval and reporting amount from the location information request common IEs.

The LMF device may transmit a QoS selection message indicating one or more selected QoS parameters to the terminal via the satellite base station (S520). For example, the LMF device may request a higher horizontal accuracy, such as a half-meter accuracy. The terminal may receive the QoS selection message from the LMF device via the satellite base station and select QoS parameter(s) based on the received QoS selection message.

The satellite base station may transmit PRSs to the terminal. For example, the LMF device may allow or trigger the satellite base station to transmit the PRSs to the terminal. Accordingly, the satellite base station may transmit the PRSs to the terminal. The terminal may receive the PRSs from the satellite base station. The terminal may measure the PRSs and generate a location information report reflecting the selected QoS parameters. For example, the terminal may generate the location information report based on m samples of PRS resource instances within a PRS measurement window. Each of the m samples may be based on a single PRS occasion within the PRS measurement window. Here, m may be a positive integer.

The terminal may provide the location information reports to the LMF device via the satellite base station (S530). The terminal may provide the location information reports reflecting the selected QoS parameters to the LMF device via the satellite base station at time intervals based on a transmission periodicity derived from the reporting interval and the number of transmissions based on the reporting amount.

For example, the reporting interval may be set to 256 seconds, and the reporting amount may be set to 256 times. In this case, the terminal may transmit the location information reports 256 times at intervals of 256 seconds. In this case, the terminal may transmit the location information reports to the satellite base station. The satellite base station may receive the location information reports from the terminal. The satellite base station may forward the received location information reports to the LMF device. The LMF device may receive the location information report from the terminals via the satellite base station and verify the terminal's location. Additionally, the LMF device may generate a control signal based on the verified location of the terminal and provide the control signal to the satellite base station. The satellite base station may receive the control signal from the LMF device and control the terminal according to the received control signal.

Meanwhile, the terminal may not identify the reporting interval from the location information request common IEs. In this case, the terminal may regard the response time as the reporting interval. The terminal may then provide the location information reports to the LMF device via the satellite base station at time intervals based on a transmission periodicity derived from the response time and the number of transmissions based on the reporting amount. The LMF device may receive the location information reports reflecting the selected QoS parameters from the terminal via the satellite base station and verify the terminal's location. Additionally, the LMF device may generate a control signal based on the verified location of the terminal and provide the control signal to the satellite base station. The satellite base station may receive the control signal from the LMF device and control the terminal according to the received control signal.

The above-described exemplary embodiment according to the present disclosure is characterized by enabling operations for user location verification in satellite networks, which differ significantly in physical structure from terrestrial networks, using parameters and operations previously employed for location verification in terrestrial networks. For example, a single reporting instruction may facilitate multiple reports required for the satellite environment.

FIG. 6 is a sequence chart illustrating exemplary embodiments of a location verification method in a communication system.

Referring to FIG. 6, an LMF device may configure location information request common IEs (e.g. CommonIEsRequestLocationInformation). The location information request common IEs may include information indicating a location reporting type. For example, the location reporting type may be the periodic reporting type, the response time-based reporting type, or the event-based reporting type. In the case where the location reporting type is the event-based reporting type, the information indicating the location reporting type may be a triggered reporting IE (e.g. triggeredReporting IE).

Accordingly, the location information request common IEs may include, for example, the triggered reporting IE (e.g. triggeredReporting IE) which includes triggered reporting criteria (e.g. triggeredReportingCriteria). Here, the triggered reporting criteria may include, for example, a trigger condition (e.g. cell change), a reporting duration (e.g. reportingDuration), a reporting interval (e.g. reportingInterval), or a reporting amount (e.g. reportingAmount). The event-based reporting may be initiated by the LMF or network recognizing an event or by the terminal recognizing an event that has pre-acquired relevant IEs from the LMF or network.

The above-described exemplary embodiment according to the present disclosure is characterized by enabling operations for user location verification in satellite networks, which differ significantly from terrestrial networks, using parameters and operations previously employed for location verification in terrestrial networks. For example, a single event occurrence may facilitate multiple reports required for the satellite environment.

The reporting duration may represent a duration over which location information reports are transmitted. The reporting interval may represent an interval between location information reports. For example, the reporting interval may be set to ri0-25, ri0-5, ri1, ri2, ri4, ri8, ri16, ri32, ri64, ri128, or ri256. The enumerated reporting intervals may correspond to transmission periodicities of 1, 2, 4, 8, 16, 32, 64, 128, and 256 seconds, respectively. The reporting amount may indicate the number of requested periodic location information reports. For example, the reporting amount may be set to ra1, ra2, ra4, ra8, ra16, ra32, ra64, ra128, ra256, or ra-Infinity. The enumerated reporting amounts may correspond to 1, 2, 4, 8, 16, 32, 64, 128, 256, and an infinite/indefinite number of transmissions, respectively.

The LMF device may transmit a location information request message (e.g. requestLocationInformation) which includes the configured location information request common IEs to the terminal via the satellite base station (S610). Subsequently, the terminal may receive the location information request message, which includes the location information request common IEs, from the LMF device via the satellite base station. The terminal may identify the triggered reporting IE from the location information request common IEs of the received location information request message. Through the identified triggered reporting IE, the terminal may determine that the location reporting type is the event-based reporting type. The terminal may identify the triggered reporting criteria, such as the trigger condition, reporting duration, reporting interval, and reporting amount, from the location information request common IEs.

The terminal may detect occurrence of the trigger condition. In this case, the satellite base station may transmit a PRS to the terminal. The terminal may receive the PRS, measure the received PRS, and generate a location information report. The terminal may then transmit the generated location information report to the LMF device (S620). In this case, the terminal may identify the reporting interval and reporting amount and transmit the location information reports to the LMF device at a transmission periodicity based on the identified reporting interval and the number of transmissions based on the identified reporting amount. If the terminal is not able to identify the reporting interval, the terminal may consider the reporting duration as the reporting interval and transmit the location information reports to the LMF device at a transmission periodicity based on the identified reporting duration and the number of transmissions based on the identified reporting amount.

Meanwhile, the terminal may interpret the reporting duration as the maximum interval for each location information report. The terminal may randomly select a transmission periodicity shorter than the value indicated by the reporting duration and transmit the location information reports to the LMF device via the satellite base station. In other words, the terminal may transmit the location information reports to the satellite base station. The satellite base station may receive the location information reports from the terminal. The satellite base station may forward the received location information reports to the LMF device. The LMF device may receive the location information reports from the terminal via the satellite base station and verify the terminal's location. Additionally, the LMF device may generate a control signal based on the verified location of the terminal and provide the control signal to the satellite base station. The satellite base station may receive the control signal from the LMF device and control the terminal according to the received control signal.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a base station, comprising:
receiving, from a location management function (LMF) device, location information request common information elements (IEs) including indication information on a location information reporting type and reporting criteria information on reporting criteria according to the location information reporting type;
providing, to a terminal, the location information request common IEs including the indication information and the reporting criteria information;
receiving, from the terminal, a location information report according to the indication information and the reporting criteria information; and
providing the received location information report to the LMF device.

2. The method according to claim 1, wherein the location information reporting type is at least one of a periodic reporting, response time-based reporting, or event-based reporting.

3. The method according to claim 2, wherein when the location information reporting type is the periodic reporting, the indication information is a periodic report IE, and the reporting criteria information includes at least one of a reporting interval, a reporting amount, or an interval unit.

4. The method according to claim 3, wherein the reporting interval is at least one of 1 second, 2 seconds, 4 seconds, 8 seconds, 16 seconds, 32 seconds, 64 seconds, 128 seconds, or 256 seconds, the reporting amount is at least one of 1 time, 2 times, 4 times, 8 times, 16 times, 32 times, 64 times, 128 times, or 256 times, and the interval unit is at least one of 1 second, 2 seconds, 3 seconds, or 4 seconds.

5. The method according to claim 3, wherein a transmission periodicity of the location information report is set to a value obtained by multiplying the reporting interval by the interval unit.

6. The method according to claim 2, wherein when the location information reporting type is the response time-based reporting, the indication information is a response time parameter, and the reporting criteria information includes at least one of a response time, a reporting interval, or a reporting amount.

7. The method according to claim 2, wherein when the location information reporting type is the event-based reporting, the indication information is a triggered reporting IE, and the reporting criteria information includes at least one of a reporting event, a reporting duration, a reporting interval, or a reporting amount.

8. A method of a terminal, comprising:
receiving, from a base station, location information request common information elements (IEs) including indication information on a location information reporting type and reporting criteria information on reporting criteria according to the location information reporting type;
identifying the location information reporting type based on the indication information;
identifying the reporting criteria information according to the identified location information reporting type;
generating location information based on the location information reporting type; and
transmitting the generated location information to the base station according to the reporting criteria information.

9. The method according to claim 8, wherein the identifying of the location information reporting type based on the indication information comprises:
identifying a periodic reporting IE as the indication information from the location information request common IEs; and
in response to identifying the periodic reporting IE, determining the location information reporting type as a periodic reporting.

10. The method according to claim 8, wherein the identifying of the location information reporting type based on the indication information comprises:
identifying a response time parameter as the indication information from the location information request common IEs; and
in response to identifying the response time parameter, determining the location information reporting type as a response time-based reporting.

11. The method according to claim 8, wherein the identifying of the location information reporting type based on the indication information comprises:
identifying a triggered reporting IE as the indication information from the location information request common IEs; and
in response to identifying the triggered reporting IE, determining the location information reporting type as an event-based reporting.

12. The method according to claim 8, wherein when the location information reporting type is a periodic reporting, the reporting criteria information includes at least one of a reporting interval, a reporting amount, or an interval unit.

13. The method according to claim 12, wherein the reporting interval is at least one of 1 second, 2 seconds, 4 seconds, 8 seconds, 16 seconds, 32 seconds, 64 seconds, 128 seconds, or 256 seconds, the reporting amount is at least one of 1 time, 2 times, 4 times, 8 times, 16 times, 32 times, 64 times, 128 times, or 256 times, and the interval unit is at least one of 1 second, 2 seconds, 3 seconds, or 4 seconds.

14. The method according to claim 12, wherein a transmission periodicity of the location information report is set to a value obtained by multiplying the reporting interval by the interval unit.

15. The method according to claim 8, wherein when the location information reporting type is a response time-based reporting, the reporting criteria information includes at least one of a response time, a reporting interval, or a reporting amount.

16. The method according to claim 8, wherein when the location information reporting type is an event-based reporting, the reporting criteria information includes at least one of a reporting event, a reporting duration, a reporting interval, or a reporting amount.

17. A terminal comprising a processor, wherein the processor causes the terminal to perform:
receiving, from a base station, location information request common information elements (IEs) including indication information on a location information reporting type and reporting criteria information on reporting criteria according to the location information reporting type;
identifying the location information reporting type based on the indication information;
identifying the reporting criteria information according to the identified location information reporting type;
generating location information based on the location information reporting type; and
transmitting the generated location information to the base station according to the reporting criteria information.

18. The terminal according to claim 17, wherein in the identifying of the location information reporting type based on the indication information, the processor causes the terminal to perform:
identifying a periodic reporting IE as the indication information from the location information request common IEs; and
in response to identifying the periodic reporting IE, determining the location information reporting type as a periodic reporting.

19. The terminal according to claim 17, wherein in the identifying of the location information reporting type based on the indication information, the processor causes the terminal to perform:
identifying a response time parameter as the indication information from the location information request common IEs; and
in response to identifying the response time parameter, determining the location information reporting type as a response time-based reporting.

20. The terminal according to claim 17, wherein in the identifying of the location information reporting type based on the indication information, the processor causes the terminal to perform:
identifying a triggered reporting IE as the indication information from the location information request common IEs; and
in response to identifying the triggered reporting IE, determining the location information reporting type as an event-based reporting.
